(19) United States
(12) Patent Application Publication
(10) Pub. No.: US 2011/0206293 A1
(43) Pub. Date: Aug. 25, 2011

(54) IMAGE PROCESSING APPARATUS, IMAGE PROCESSING METHOD, AND COMPUTER READABLE MEDIUM STORING PROGRAM THEREOF

(75) Inventor: Makoto SASAKI, Kanagawa (JP)

(73) Assignee: FUJI XEROX CO., LTD., Tokyo (JP)

(21) Appl. No.: 12/857,072

(22) Filed: Aug. 16, 2010

(30) Foreign Application Priority Data
Feb. 19, 2010 (JP) 2010-035313

(51) Int. Cl. G06K 9/36

(52) U.S. Cl. 382/274

(57) ABSTRACT

An image processing apparatus includes a band decomposition unit, an intensity calculation unit, and a band-weighted image generation unit. The band decomposition unit decomposes a given original image into frequency component images each corresponding to an individual frequency band. The intensity calculation unit sets each pixel as a target pixel for processing, and calculates an intensity of a frequency component in each frequency band for a local area having a predetermined size including the target pixel for processing. The band-weighted image generation unit generates a band-weighted image by determining a frequency band to which the target pixel for processing belongs in accordance with intensities of frequency components in the local area and by assigning a weighted value for the frequency band to each pixel in the local area.

### CROSS-REFERENCE TO RELATED APPLICATIONS

This application is based on and claims priority under 35 USC 119 from Japanese Patent Application No. 2010-035313 filed Feb. 19, 2010.

### BACKGROUND

(i) Technical Field

The present invention relates to an image processing apparatus, an image processing method, and a computer readable medium storing a program thereof.

(ii) Related Art

Image processing techniques include an image enhancement technique for emphasizing color or density boundaries, contours, and the like in an image or for enhancing a specific frequency band. The image enhancement technique is utilized in various fields. For example, with the use of the image enhancement technique, the texture of natural images may be improved or, in the medical imaging field, X-ray photographs may be corrected to increase the visibility of objects.

Recently, the focus of such image enhancement techniques has shifted to reproduction with the aim of improving “texture”. Unsharp masking (USM) is an existing technique in which a high-frequency enhancement filter is applied to an entire image to make contours or patterns pronounced.

However, USM processing does not always provide improvement in the texture of every natural image. Depending on the picture, for example, a viewer may feel “noise is pronounced” or “a certain feature is pronounced excessively so that the picture looks unnatural”. Such an uncomfortable feeling may be due to human visual characteristics which may react differently depending on the frequency band of the picture.

### SUMMARY

According to an aspect of the invention, there is provided an image processing apparatus including a band decomposition unit, an intensity calculation unit, and a band-weighted image generation unit. The band decomposition unit decomposes a given original image into frequency component images each corresponding to an individual frequency band. The intensity calculation unit sets each pixel as a target pixel for processing, and calculates an intensity of a frequency component in each frequency band for a local area having a predetermined size including the target pixel for processing. The band-weighted image generation unit generates a band-weighted image by determining a frequency band to which the target pixel for processing belongs in accordance with intensities of frequency components in the local area and by assigning a weighted value for the frequency band to each pixel in the local area.

### BRIEF DESCRIPTION OF THE DRAWINGS

Exemplary embodiment(s) of the present invention will be described in detail based on the following figures, wherein:

FIG. 1 is a configuration diagram illustrating a first exemplary embodiment of the present invention;

FIG. 2 is a diagram depicting a specific example of the operation of a band decomposition unit;

FIG. 3 is a diagram depicting an example of a DOG function;

FIGS. 4A and 4B are diagrams depicting an example of the relationship between control parameters of a DOG function and characteristics;

FIG. 5 is a diagram depicting a first specific example of the operation of an intensity calculation unit and a band-weighted image generation unit (in case of a second frequency band);

FIG. 6 is a diagram depicting the first specific example of the operation of the intensity calculation unit and the band-weighted image generation unit (in case of a first frequency band);

FIG. 7 is a diagram depicting a second specific example of the operation of the intensity calculation unit and the band-weighted image generation unit (in case of a second frequency band);

FIG. 8 is a diagram depicting the second specific example of the operation of the intensity calculation unit and the band-weighted image generation unit (in case of a first frequency band);

FIG. 9 is a diagram depicting an example of the relationship between frequency and enhancement level;

FIG. 10 is a diagram depicting a third specific example of the operation of the intensity calculation unit and the band-weighted image generation unit;

FIG. 11 is a diagram depicting an example of the operation of an image enhancement unit in the third specific example of the operation of the intensity calculation unit and the band-weighted image generation unit;

FIG. 12 is a diagram depicting another specific example of the operation of the band decomposition unit;

FIG. 13 is a diagram depicting an example of an orientation-selectivity DOG function;

FIG. 14 is a configuration diagram illustrating a second exemplary embodiment of the present invention; and

FIG. 15 is a block diagram of an example of a computer program, a storage medium storing the computer program, and a computer when functions described in the respective exemplary embodiments of the present invention are implemented using a computer program.

### DETAILED DESCRIPTION

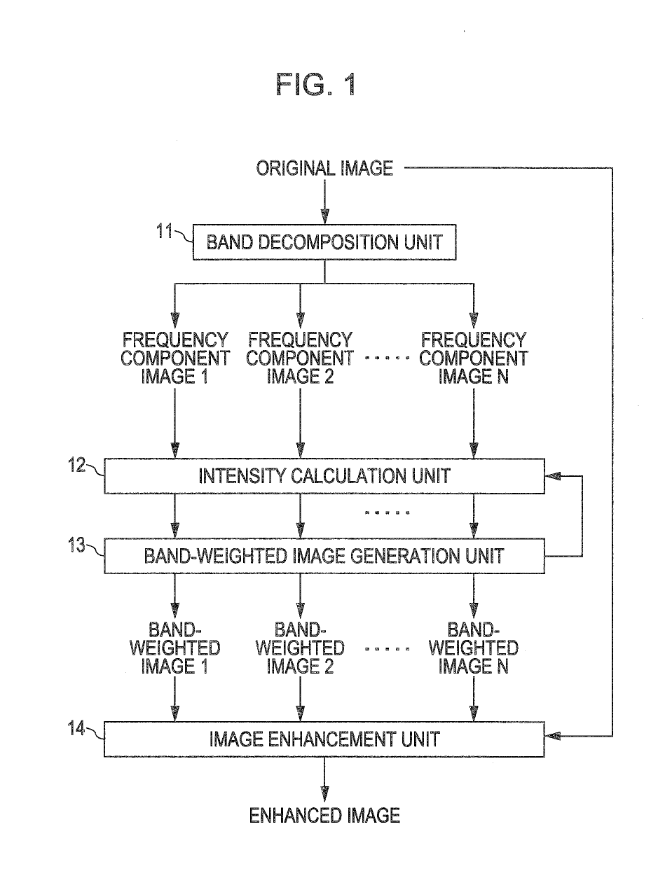

FIG. 1 is a configuration diagram illustrating a first exemplary embodiment of the present invention. An example configuration illustrated in FIG. 1 includes a band decomposition unit 11, an intensity calculation unit 12, band-weighted image generation unit 13, and an image enhancement unit 14. The band decomposition unit 11 decomposes a given original image into frequency component images corresponding to predetermined frequency bands.

The intensity calculation unit 12 sequentially sets each pixel as a target pixel for processing, and analyzes frequency characteristics for a local area having a predetermined size including the target pixel to calculate the intensities of frequency components in each frequency band.

The band-weighted image generation unit 13 determines a frequency band to which a target pixel for processing belongs in accordance with the intensities of frequency components in a local area, and assigns a weighted value for the frequency band to each pixel in the local area, thereby generating a band-weighted image. A frequency band having the highest intensities of the frequency components may be determined to be the frequency band to which a target pixel for processing belongs. A weighted value may be implemented using an intensity corresponding to the frequency band to which a target pixel for processing belongs. Alternatively, a value corresponding to the distance from a target pixel may be assigned as a weighted value. A weighted value assigned to a pixel other than a target pixel for processing may be added to the weighted value previously assigned to the pixel to produce a new weighted value. In this manner, a band-weighted image corresponding to each frequency band is generated using the weighted values of the individual pixels. It is to be understood that weighted values to be added or weighted values in a band-weighted image that has already been generated may be normalized.

The image enhancement unit 14 performs an enhancement process for each frequency band in an original image in accordance with the weighted values in the band-weighted image corresponding to the frequency band, which are generated by the band-weighted image generation unit 13. The image enhancement unit 14 may not necessarily be included in the configuration if the band-weighted images are used for purposes other than image enhancement, such as determining feature values for use in an image search.

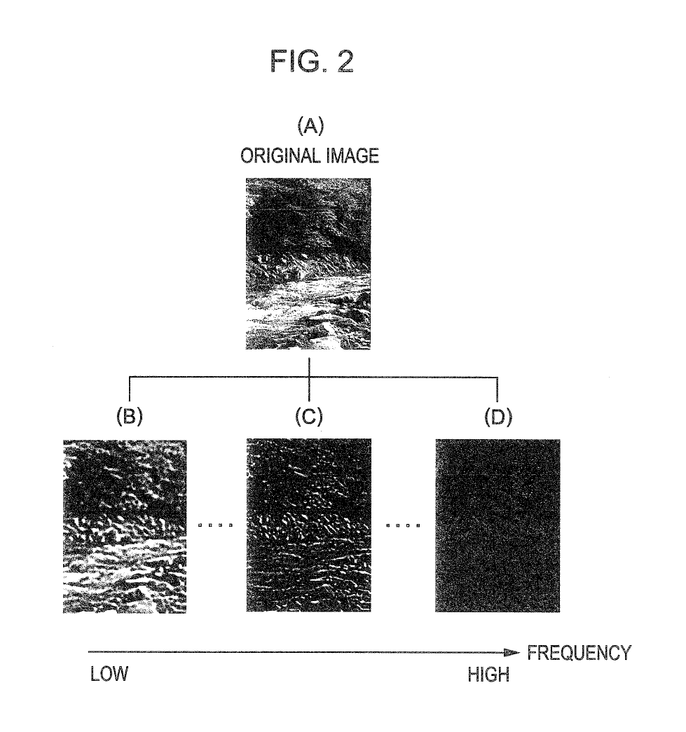

The above configuration will further be described using a specific example. FIG. 2 is a diagram depicting a specific example of the operation of the band decomposition unit 11. The band decomposition unit 11 decomposes an original image into frequency component images corresponding to individual frequency bands. The original image is illustrated in part (A) of FIG. 2, and the obtained frequency component images corresponding to the individual frequency bands are illustrated in, in this example, parts (B), (C), and (D) of FIG. 2. The original image may be decomposed into frequency component images corresponding to individual frequency bands using a known technique such as wavelet analysis or a method using a difference of two Gaussians (DOG) function.

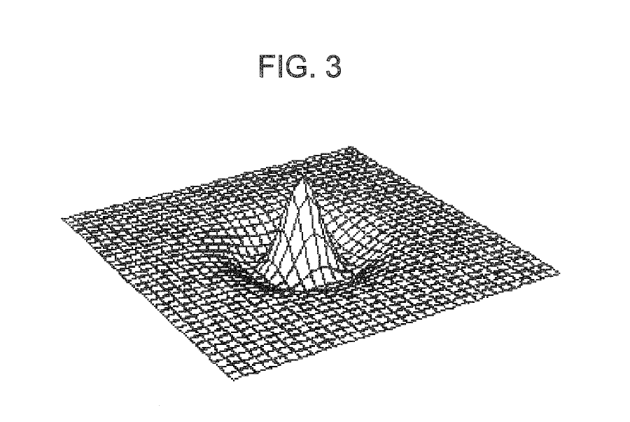

FIG. 3 is a diagram depicting an example of a DOG function. The DOG function is known as a mathematical model of visual characteristics in the human brain, and is a function that represents a two-dimensional profile illustrated in, for example, FIG. 3. The DOG function is represented by Equation (1) as follows:

G_{DOG}(x,y)=(1/(2πσₑ²))e^{te}−A·(1/(2πσᵢ²))e^{ti} (1)

te=−(x²+y²)/(2σₑ²)

ti=−(x²+y²)/(2σᵢ²)

where σₑ, σᵢ, and A are control parameters. The control parameters σₑ, σᵢ, and A may be changed to control a frequency band, the intensity of the response to the frequency band, and the like.

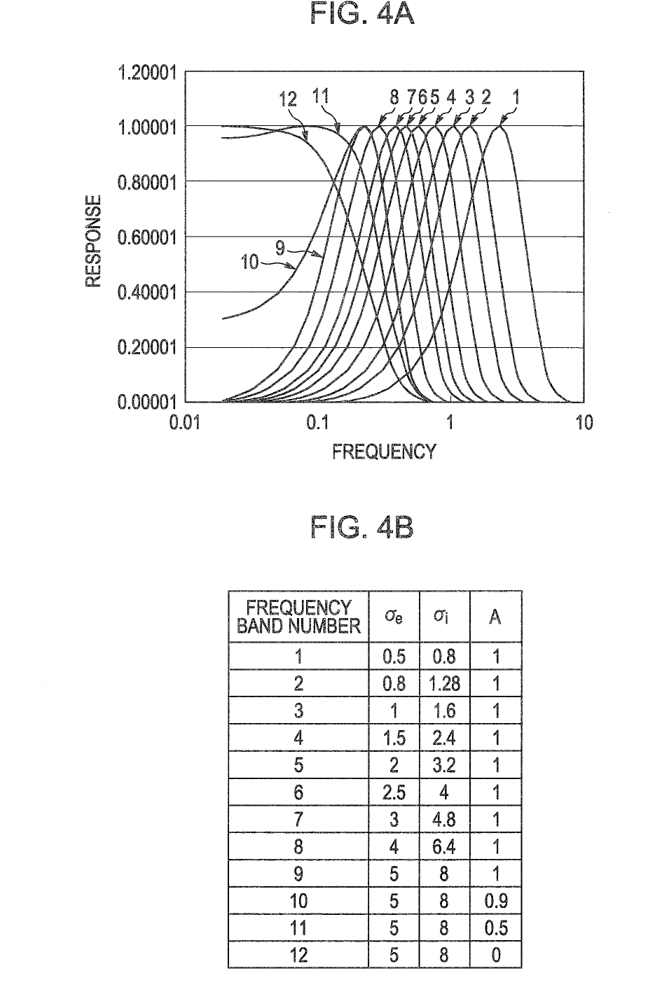

FIGS. 4A and 4B are diagrams depicting an example of the relationship between the control parameters of the DOG function and characteristics. FIG. 4A illustrates frequency bands which may be changed by controlling the parameters σₑ, σᵢ, A in Equation (1). The higher the response on the vertical axis, the higher the intensity of the response to a specific frequency band. FIG. 4B illustrates an example of control parameters for providing a response to a specific frequency band. In FIG. 4B, the values in the “frequency band number” column correspond to the numbers given in FIG. 4A.

In the control parameters, the lower the parameter σₑ, the higher the intensity of the response to high frequencies, and the parameter σᵢ is set to a value larger than the parameter σₑ. In the illustrated example, the value of the parameter σₑ with respect to the frequency band number “1” is the smallest, and, in this case, a peak appears at the highest frequency. As the value of the parameter σₑ becomes larger than the value of the parameter σₑ with respect to the frequency band number “1”, the frequencies of peaks decrease.

Further, the control parameter A is adapted to control the relative intensities of a positive Gaussian and a negative Gaussian. The closer to 0 the value of the parameter A is, the closer to a filter for “blur” the filter is. In the illustrated example, the values of the control parameter A with respect to the frequency band numbers “9” to “12” are changed, by way of example, and frequency characteristics illustrated as examples in FIG. 4A are obtained.

The band decomposition unit 11 filters the original image using some functions obtained by modifying the control parameters in Equation (1) as filters. As a result of the filtering process, the original image is decomposed into, for example, frequency component images as illustrated in parts (B), (C), and (D) of FIG. 2.

At least one frequency band may be used for band decomposition. As a result of decomposition, only a specific band may be obtained, or roughly two frequency bands, for example, a low-middle frequency band and a high-frequency band, or the like may be obtained. It is to be understood that the band decomposition method is not limited to a method based on a DOG function.

After the band decomposition unit 11 decomposes the original image into frequency component images in the manner described above, the intensity calculation unit 12 calculates, for each local area, the intensities of frequency components in each frequency band. Then, the band-weighted image generation unit 13 determines the frequency band to which a target pixel for processing belongs, and assigns the weighted value for the frequency band, thereby generating a band-weighted image.

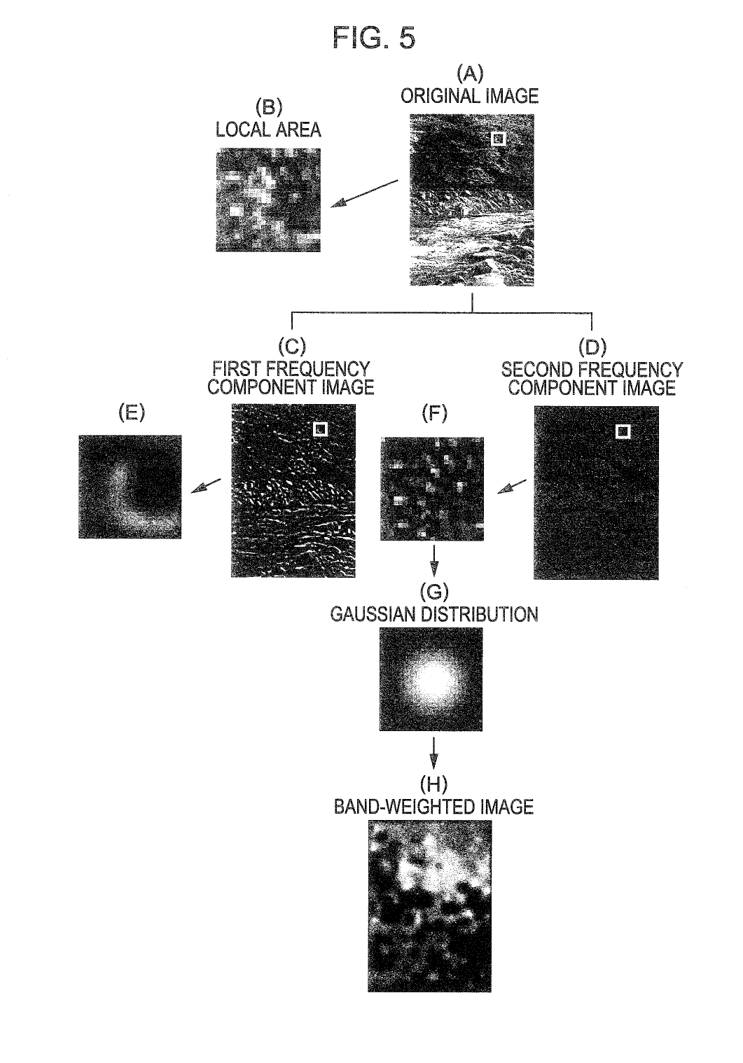

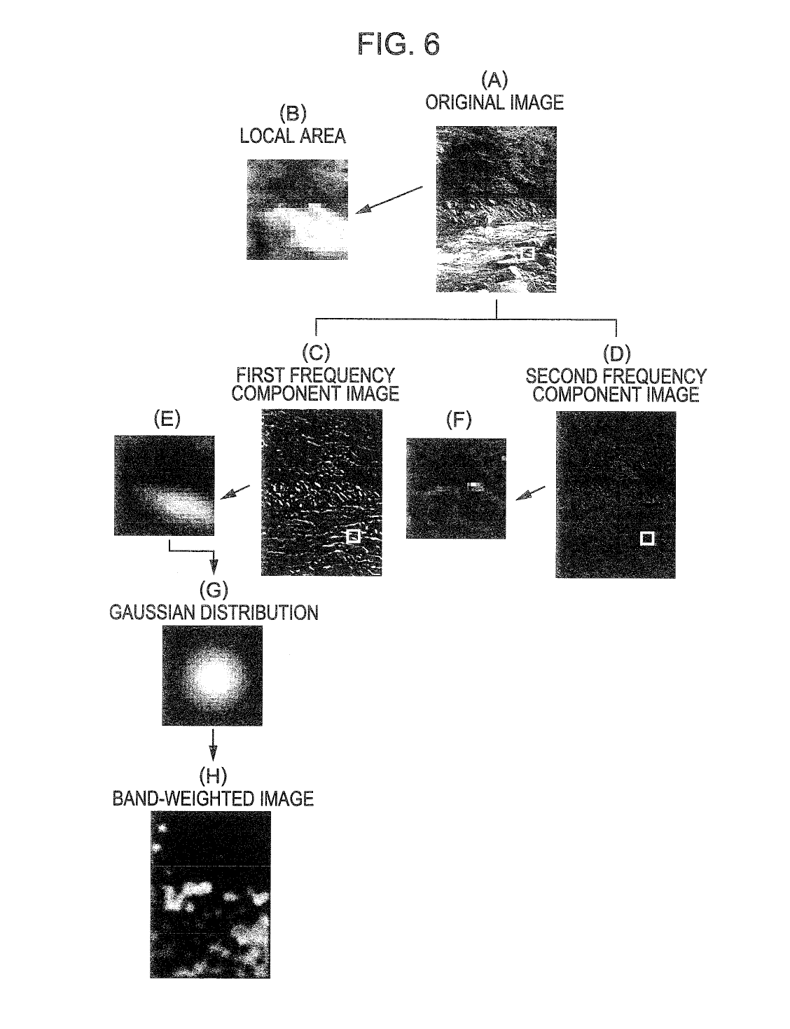

FIGS. 5 and 6 are diagrams depicting a first specific example of the operation of the intensity calculation unit 12 and the band-weighted image generation unit 13. Part (A) of FIG. 5 and part (A) of FIG. 6 illustrate an original image, and parts (C) and (D) of FIG. 5 and parts (C) and (D) of FIG. 6 illustrate frequency component images obtained by the band decomposition unit 11 as a result of decomposition. In this specific example, two frequency bands are obtained as a result of decomposition, by way of example. The frequency bands are obtained as a result of decomposition in such a manner that the frequency band corresponding to first frequency component images illustrated in part (C) of FIG. 5 and part (C) of FIG. 6 may be lower than that corresponding to second frequency component images illustrated in part (D) of FIG. 5 and part (D) of FIG. 6 and that the frequency band corresponding to the second frequency component images illustrated in part (D) of FIG. 5 and part (D) of FIG. 6 may be higher than that corresponding to the first frequency component images illustrated in part (C) of FIG. 5 and part (C) of FIG. 6.

First, a process for a local area that is set for a certain target pixel for processing will be described. In part (A) of FIG. 5 and part (A) of FIG. 6, local areas set for different target pixels for processing in the original image are indicated by white frames, and enlarged images of the local areas are illustrated in part (B) of FIG. 5 and part (B) of FIG. 6. The local area illustrated in FIG. 5 is an area including a larger number of high-frequency components than the other areas, and the local area illustrated in FIG. 6 is an area having a smaller number of high-frequency components than the other areas. Enlarged images of the areas in the respective frequency component images corresponding to the local areas are illustrated in parts (E) and (F) of FIG. 5 and parts (E) and (F) of FIG. 6. The image illustrated in part (E) of FIG. 5 is an enlarged image of the local area in the first frequency component image illustrated in part (C) of FIG. 5, and the image illustrated in part (F) of FIG. 5 is an enlarged image of the local area in the second frequency component image illustrated in part (D) of FIG. 5. Further, the image illustrated in part (E) of FIG. 6 is an enlarged image of the local area in the first frequency component image illustrated in part (C) of FIG. 6, and the image illustrated in part (F) of FIG. 6 is an enlarged image of the local area in the second frequency component image illustrated in part (D) of FIG. 6.

If a certain local area is referred to for each frequency band, the obtained image may differ from frequency band to frequency band. For example, as may be seen from the comparison of parts (E) and (F) of FIG. 5 or of parts (E) and (F) of FIG. 6, the first frequency component image corresponding to the frequency band lower than that of the second frequency component image, which is obtained as a result of decomposition, may be obtained as an image including a larger aggregate, and the second frequency component image corresponding to the frequency band higher than that of the first frequency component image, which is obtained as a result of decomposition, may be obtained as an image including a finer pattern. The intensity calculation unit 12 calculates the intensities of frequency components as a criterion used by the band-weighted image generation unit 13 to determine the feature of the image of the local area.

An intensity may be calculated using, for example, a maximum value in a local area in each frequency component image as a representative value. As described above, for example, when each frequency component image is obtained using a filtering process, the value of each pixel in the frequency component image serves as a response value in the frequency band corresponding to the frequency component image, and a maximum response value may be used as a representative value of the local area. The average of the response values may be used as the representative value. In this case, however, if the frequency band is high, response values may be dispersed and the average may not reflect the dispersed response values.

The band-weighted image generation unit 13 selects the largest representative value among the representative values indicating the intensities in each frequency band calculated by the intensity calculation unit 12, and determines that the local area belongs to the frequency band corresponding to the selected representative value. Then, the band-weighted image corresponding to the frequency band to which the local area belongs is assigned a weighted value. A value corresponding to the distance from a target pixel for processing may be assigned as the weighted value. For example, a weighted value may be assigned in accordance with a Gaussian distribution in which a target pixel for processing located at the center position of the local area exhibits a maximum (representative value). A maximum weighted value may be used as a representative value or a representative value may be normalized to a value such as 1. No weighted values are assigned to the band-weighted images corresponding to the other frequency bands. For a pixel in a band-weighted image assigned a weighted value, the assigned weighted value is added to the weighted value previously assigned to the pixel to produce a new weighted value. In a band-weighted image, it is assumed that weighted values for individual pixels are initialized to 0.

For example, the local area in the example illustrated in FIG. 5 is an area having a larger number of high-frequency components than the other areas. Thus, the intensities obtained from the second frequency component image, which are calculated by the intensity calculation unit 12, have larger values than the intensities obtained from the first frequency component image, which are calculated by the intensity calculation unit 12. Therefore, the band-weighted image generation unit 13 determines that the local area belongs to the frequency band corresponding to the second frequency component image. Then, in accordance with a Gaussian distribution illustrated in part (G) of FIG. 5, weighted values are assigned to the pixels in the local area in the corresponding band-weighted image (part (H) of FIG. 5), and sums are calculated. A weighted value for each pixel in the local area may be determined by, for example, multiplying the weight at the position of the pixel in accordance with the Gaussian distribution by the representative value or the intensity for the pixel in the frequency band. No weighted values are assigned to the band-weighted image corresponding to the frequency band of the first frequency component image to which the local area does not belong.

Meanwhile, for example, the local area in the example illustrated in FIG. 6 is an area having a larger number of low-frequency components than the other areas. Thus, the intensities obtained from the first frequency component image, which are calculated by the intensity calculation unit 12, have larger values than the intensities obtained from the second frequency component image, which are calculated by the intensity calculation unit 12. Therefore, the band-weighted image generation unit 13 determines that the local area belongs to the frequency band corresponding to the first frequency component image. Then, in accordance with a Gaussian distribution illustrated in part (G) of FIG. 6, weighted values are assigned to the pixels in the local area in the corresponding band-weighted image (part (H) of FIG. 6), and sums are calculated. A weighted value for each pixel in the local area may be determined by, for example, multiplying the weight at the position of the pixel in accordance with the Gaussian distribution by the representative value or the intensity for the pixel in the frequency band. No weighted values are assigned to the band-weighted image corresponding to the frequency band of the second frequency component image to which the local area does not belong.

In the intensity calculation unit 12 and the band-weighted image generation unit 13, each pixel in an image (an original image or a frequency component image) is sequentially set as a target pixel for processing, and the above process is performed on a local area having a predetermined size including the target pixel. The process is performed until no other target pixel remains, and band-weighted images corresponding to the respective frequency bands are generated using the previously assigned weighted values. An example of a created band-weighted image corresponding to the frequency band of the second frequency component image is illustrated in part (H) of FIG. 5, and an example of a created band-weighted image corresponding to the frequency band of the first frequency component image is illustrated in part (H) of FIG. 6. Pixels may be sequentially set as target pixels for processing, or every several pixels may be set as target pixels for processing. Alternatively, an image may be divided into blocks in accordance with the size of the local area and the process may be performed block-by-block.

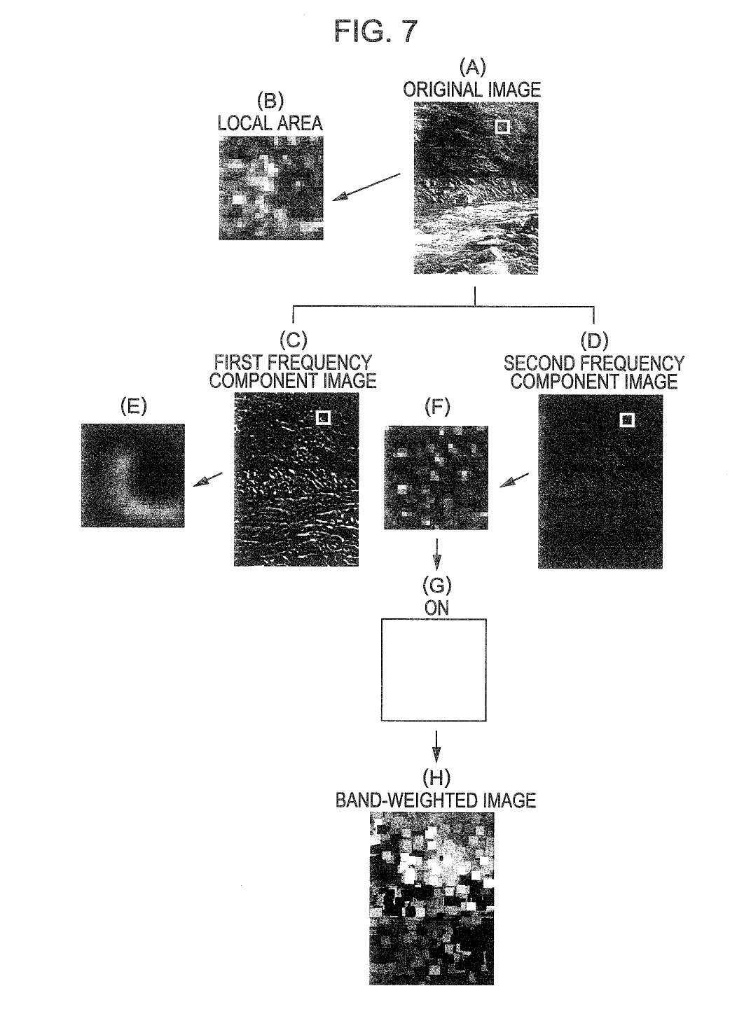

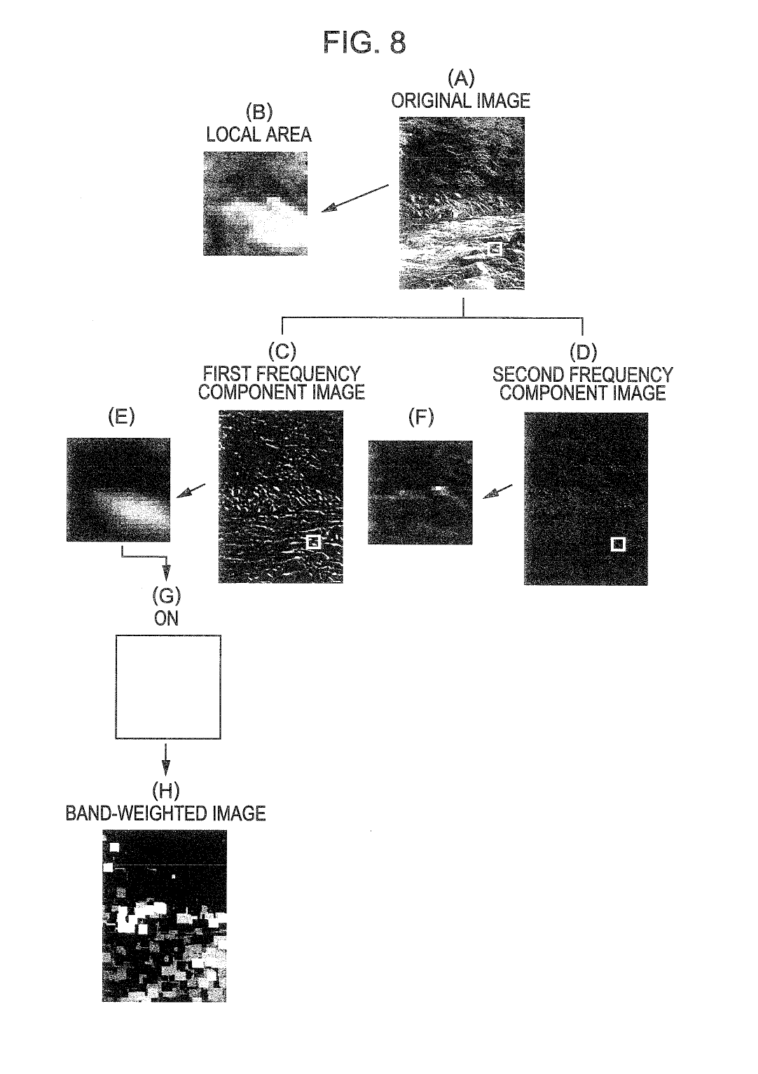

In the above example, weighted values are assigned in accordance with a Gaussian distribution, by way of example. The method for assigning a weighted value to each pixel in a local area is not limited to that described above. FIGS. 7 and 8 are diagrams depicting a second specific example of the operation of the intensity calculation unit 12 and the band-weighted image generation unit 13. Parts (A), (B), (C), (D), (E), and (F) of FIG. 5 correspond to parts (A), (B), (C), (D), (E), and (F) of FIG. 7, respectively, and parts (A), (B), (C), (D), (E), and (F) of FIG. 6 correspond to parts (A), (B), (C), (D), (E), and (F) of FIG. 8, respectively. In this example, as illustrated in part (G) of FIG. 7 and part (G) of FIG. 8, each pixel in a local area is assigned a representative value or a maximum value as a weighted value, by way of example.

For example, in the example illustrated in FIG. 7, each pixel in a local area in the band-weighted image (part (H) of FIG. 7) corresponding to the frequency band to which it is determined that the local area belongs is assigned, for example, a representative value as a weighted value, and the weighted value is added to the previous weighted value. Alternatively, a weight in the local area may be set to 1, and the intensity for each pixel in the frequency band may be assigned as a weighted value and may be added to the weight. No weighted values are assigned to the band-weighted image corresponding to the frequency band of the first frequency component image to which the local area does not belong.

Further, in the example illustrated in FIG. 8, each pixel in a local area of the band-weighted image (part (H) of FIG. 8) corresponding to the frequency band to which it is determined that the local area belongs is assigned, for example, a representative value as a weighted value, and the weighted value is added to the previous weighted value. No weighted values are assigned to the band-weighted image corresponding to the frequency band of the second frequency component image to which the local area does not belong.

The intensity calculation unit 12 and the band-weighted image generation unit 13 sequentially set each pixel in an image (an original image or a frequency component image) as a target pixel for processing, and perform the above process on a local area having a predetermined size including the target pixel. Also in this case, pixels may be sequentially set as target pixels for processing, or every several pixels may be set as target pixels for processing. Alternatively, an image may be divided into blocks in accordance with the size of the local area and the process may be performed block-by-block. The process is performed until no other target pixel remains, and band-weighted images corresponding to the respective frequency bands are generated using the previously assigned weighted values. An example of a created band-weighted image corresponding to the frequency band of the second frequency component image is illustrated in part (H) of FIG. 7, and an example of a created band-weighted image corresponding to the frequency band of the first frequency component image is illustrated in part (H) of FIG. 8. The band-weighted images obtained in this way may be subjected to a blurring process using, for example, a Gaussian function or the like. Further, a normalization process may be performed so that weighted values in a band-weighted image may be within a predetermined range.

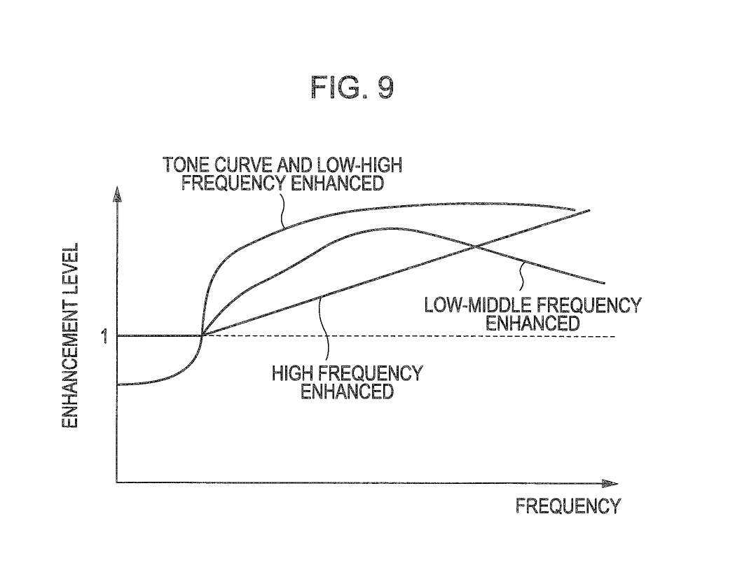

The image enhancement unit 14 performs individual enhancement processes on the original image using the created band-weighted images of the frequency bands, and combines the resulting images. FIG. 9 is a diagram depicting an example of the relationship between frequency and enhancement level. The image enhancement unit 14 may design an enhancement filter or a tone curve having, for example, the enhancement characteristics illustrated in FIG. 9, and may perform enhancement processes based on weighted values in the corresponding band-weighted images.

In FIG. 9, the enhancement level is given by (pixel value of enhanced image)/(pixel value of original image). If no enhancement process is performed, the pixel value of the enhanced image equals the pixel value of the original image, and the enhancement level is 1. If the entire image is corrected using a tone curve, the response at a frequency of 0 Hz changes. Thus, the enhancement level at a frequency of 0 Hz may have a value other than 1. Further, with frequency enhancement using unsharp masking or a DOG function, a frequency band other than a frequency of 0 Hz is enhanced. For example, in a “high frequency enhanced” curve, the enhancement level is increased in accordance with an increase in frequency. Further, in a “low-middle frequency enhanced” curve, the enhancement level is increased up to a certain frequency band and the enhancement level is gradually reduced at higher frequencies.

Further, as in a “tone curve and low-high frequency enhanced” curve illustrated in FIG. 9, when a tone curve and a frequency enhancement process are applied, the application may be implemented using Equation (2) as below or the like:

Pᵢⱼ=pᵢⱼ+α(pᵢⱼ−pᵢⱼ^{low})+βdᵢⱼ (2)

where ij denotes the position of a pixel, Pᵢⱼ denotes the pixel value of the enhanced image, pᵢⱼ denotes the pixel value of the original image, pᵢⱼ^{low} denotes an image produced by blurring the original image, α denotes a coefficient for controlling the enhancement degrees of frequency components, dᵢⱼ denotes an amount of change in pixel value based on a tone curve, and β denotes a coefficient for controlling the enhancement degrees of the tone curve.

In the original image, for example, the frequency band of the first frequency component image obtained as a result of decomposition may be subjected to an enhancement process in accordance with the characteristics indicated by the “low-middle frequency enhanced” curve using the weighted values in the corresponding band-weighted image. Further, in the original image, for example, the frequency band of the second frequency component image obtained as a result of decomposition may be subjected to an enhancement process in accordance with the characteristics indicated by the “high frequency enhanced” curve using the weighted values in the corresponding band-weighted image. Two images subjected to the enhancement processes are combined so that an image subjected to the enhancement processes in accordance with the frequency bands can be obtained. In the obtained image, the boundary between the areas on which the enhancement processes corresponding to the respective frequency bands are performed is blurred using the process of assignment of the weighted values, and enhancement processes are successively performed in accordance with the respective frequency bands.

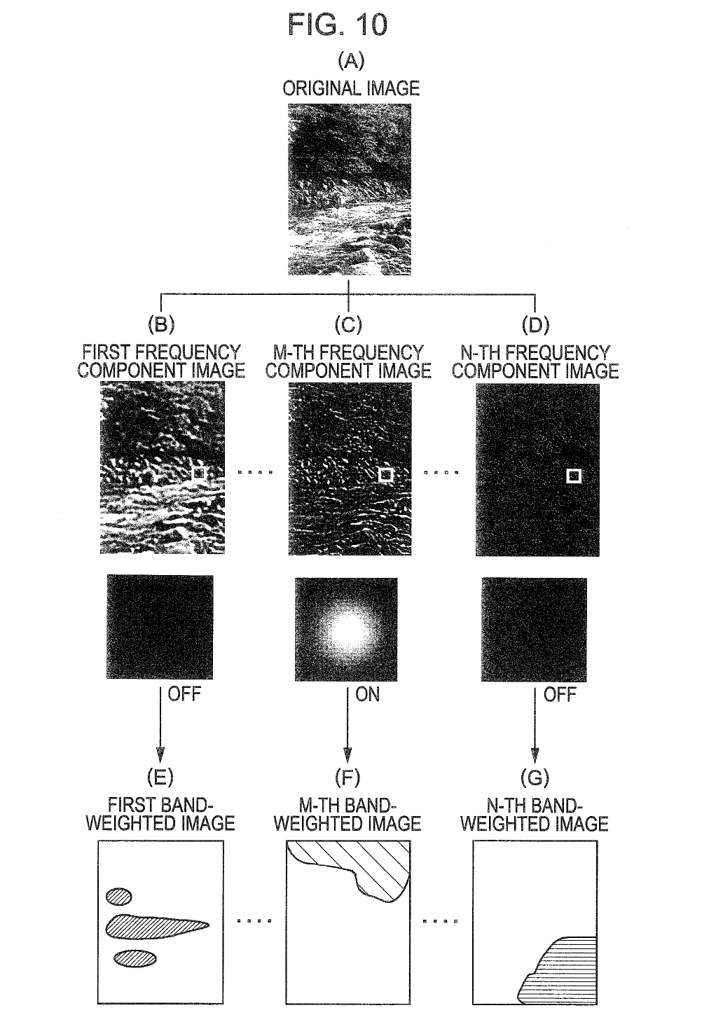

FIG. 10 is a diagram depicting a third specific example of the operation of the intensity calculation unit 12 and the band-weighted image generation unit 13. In the above examples, two frequency bands are obtained by the band decomposition unit 11, as a result of decomposition, by way of example. In contrast, in this example, N frequency bands are obtained by the band decomposition unit 11 as a result of decomposition. For convenience of description, a first frequency component image (part (B) of FIG. 10), an M-th frequency component image (1<M<N) (part (C) of FIG. 10), and an N-th frequency component image (part (D) of FIG. 10) are illustrated. Part (A) of FIG. 10 illustrates an original image.

The intensity calculation unit 12 calculates intensities in individual frequency bands for a local area including a certain target pixel for processing. The band-weighted image generation unit 13 determines a maximum value of intensity in each frequency band on the basis of the values of intensities calculated by the intensity calculation unit 12, and determines that the local area belongs to the frequency band having the largest value of intensity. In the example illustrated in FIG. 10, the intensity obtained from the M-th frequency component image may be the largest and it may be determined that the local area belongs to the M-th frequency band. Then, the band-weighted image generation unit 13 assigns a weighted value to the corresponding local area in an M-th band-weighted image. For example, in the example illustrated in FIG. 10, weighted values are assigned to the corresponding local area in the M-th band-weighted image in accordance with a Gaussian distribution, and values obtained by adding the weighted values to the previous weighted values are held. It is to be understood that the method for assigning weighted values may not necessarily be based on a Gaussian distribution, and various methods including that in the above example may be used. No weighted values may be assigned to the band-weighted images other than the M-th band-weighted image, or a weighted value of 0 may be added.

As a result of performing the above process while changing target pixels for processing, for example, a first band-weighted image illustrated in part (E) of FIG. 10 is obtained for the first frequency band, an M-th band-weighted image illustrated in part (F) of FIG. 10 is obtained for the M-th frequency band, and an N-th band-weighted image illustrated in part (G) of FIG. 10 is obtained for the N-th frequency band. Here, areas assigned weighted values other than 0 are illustrated while the weighted values are not illustrated.

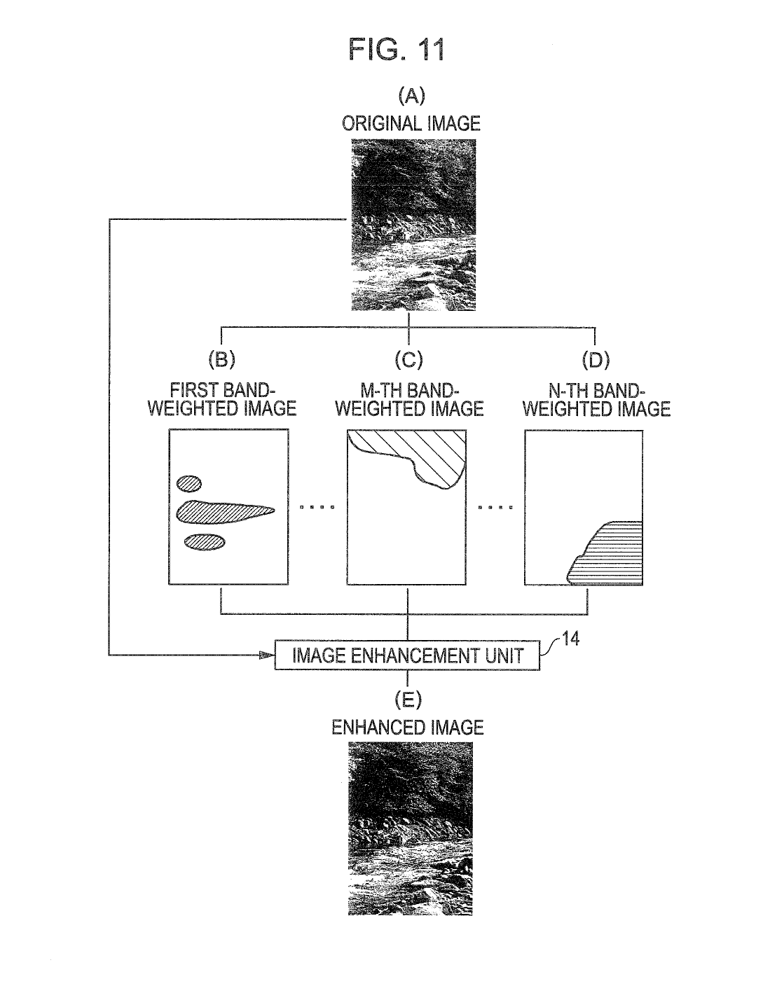

The image enhancement unit 14 performs an image enhancement process using the N band-weighted images generated by the band-weighted image generation unit 13 in accordance with the respective frequency bands and weighted values. FIG. 11 is a diagram depicting an example of the operation of the image enhancement unit 14 in the third specific example of the operation of the intensity calculation unit 12 and the band-weighted image generation unit 13. Part (A) of FIG. 11 illustrates an original image, and parts (B), (C), and (D) of FIG. 11 illustrate the band-weighted images illustrated in parts (E), (F), and (G) of FIG. 10, respectively. For example, the first frequency band may be subjected to the enhancement process corresponding to the weighted value in the first band-weighted image illustrated in part (B) of FIG. 11. Further, for example, the M-th frequency band may be subjected to the enhancement process corresponding to the weighted value in the M-th band-weighted image illustrated in part (C) of FIG. 11. In addition, for example, the N-th frequency band may be subjected to the enhancement process corresponding to the weighted value in the N-th band-weighted image illustrated in part (D) of FIG. 11. In this manner, the enhancement processes corresponding to the respective frequency components are performed on the original image, and images subjected to the enhancement processes are combined to obtain an enhanced image illustrated in part (E) of FIG. 11. Since the band-weighted image generation unit 13 assigns a weighted value to a local area, a certain pixel may be assigned weighted values other than 0 over plural band-weighted images, and may be subjected to enhancement processes for the plural frequency bands. This may ensure consecutiveness between areas having different frequency characteristics.

The enhancement processes for the respective frequency bands may be performed using different techniques, for example, different enhancement filters, or may be performed using a common enhancement filter by changing the coefficients in accordance with the individual frequency bands. For example, a filter or a tone curve having the enhancement characteristics illustrated in FIG. 9 may be designed in accordance with each frequency band, and a filter or a tone curve suited to each frequency band and intensity may be selected so that an enhancement process may be performed in accordance with a weighted value. When Equation (2) given in the illustration of FIG. 9 is used, an enhancement process may be performed in such a manner that the degree of blur of the blurred image represented by pᵢⱼ^{low} may be increased for a lower-frequency portion. Conversely, a higher-frequency portion may be blurred by a smaller amount with respect to the original image, and the degree of blur of the blurred image represented by pᵢⱼ^{Low} may be reduced. Further, the amount of correction using the tone curve represented by dᵢⱼ may be applied to the entire pixels, or the coefficient β may be controlled in accordance with the frequency band.

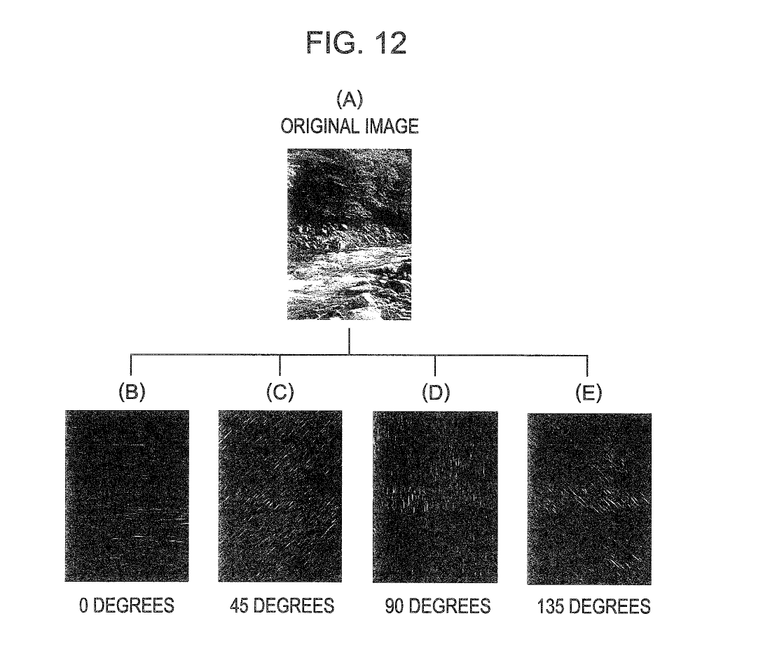

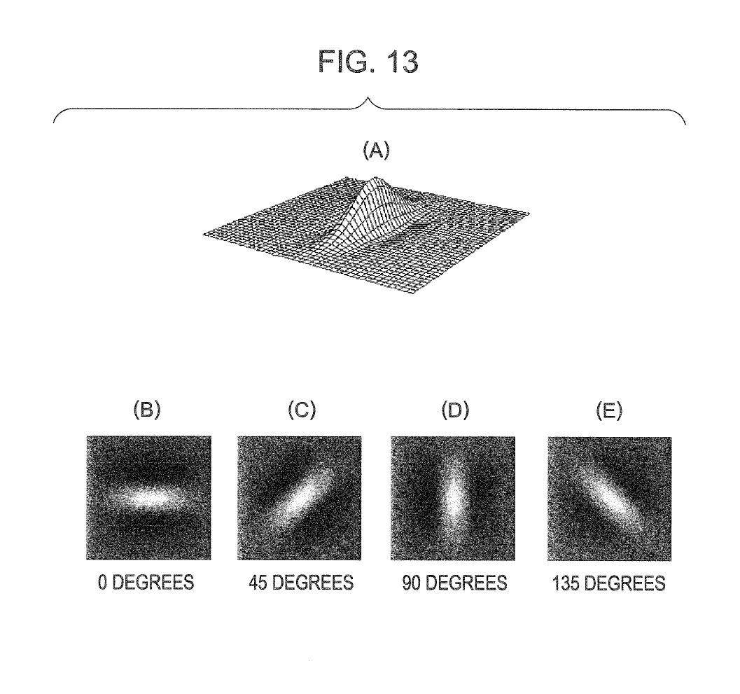

FIG. 12 is a diagram depicting a specific example of another operation of the band decomposition unit 11, and FIG. 13 is a diagram depicting an example of an orientation-selectivity DOG function. In the foregoing description, the band decomposition unit 11 performs decomposition to obtain frequency bands without taking direction into account. However, an original image may also be decomposed in terms of direction into frequency component images corresponding to individual frequency bands.

The decomposition in terms of direction may be implemented using, for example, a DOG function having orientation selectivity. An example of the DOG function having orientation selectivity is illustrated in FIG. 13. The illustrated function is represented by

H(x,y)={F(x,e)−F(x,i)}·F(y) (3)

F(x,e)=(1/√(2π)σ_{x,e})·e^{txe}

txe=−x²/(2σ_{x,e}²)

F(x,i)=(1/√(2σ_{x,i})·e^{txi}

txi=−x²/(2σ_{x,i}²)

F(y)=(1/√(2π)σ_{y})·e^{ty}

ty=−y²(2σ_{y}²)

where σ_{x,e} denotes the variance of excitation of the response to luminance components, σ_{x,i} denotes the variance of inhibition of the response, and σ_{y} denotes the variance in a specific orientation and is a parameter for determining the degree of blur of extracted orientation components.

In Equation (3), a rotation angle φ is specified to provide orientation selectivity, and Hφ(x, y) is determined by:

Hφ(x,y)=H(x·cos φ−y·sin φ,x·sin φ+y·cos φ) (4)

Therefore, a filter sensitive to a specific orientation, which is illustrated in part (A) of FIG. 13, is obtained. With the use of the filter given by Equation (4), a frequency component image responsive to a specific band and a specific orientation is generated. For example, filters for four orientations, 0 degrees, 45 degrees, 90 degrees, and 135 degrees, are illustrated in parts (B), (C), (D), and (E) of FIG. 13, respectively. Further, examples of frequency component images obtained by decomposing the original image illustrated in part (A) of FIG. 12 into specific frequency bands and four orientations are illustrated in parts (B), (C), (D), and (E) of FIG. 12.

It is to be understood that the above orientation-selectivity DOG function is merely an example, and any of various methods for decomposing an original image into frequency component images corresponding to individual frequency bands in terms of direction may be used.

The processes after the process of the intensity calculation unit 12 may be performed in the manner described above. In this case, since frequency component images obtained in terms of direction are used, noise components such as points are not enhanced. Further, the image enhancement unit 14 may perform an enhancement process by increasing or reducing the degree of enhancement for a certain direction with respect to other directions.

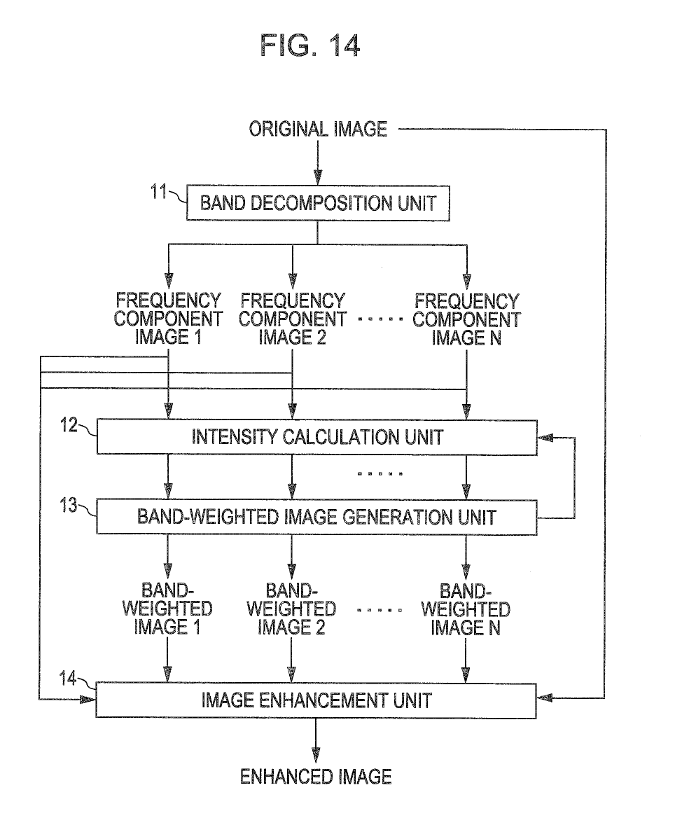

FIG. 14 is a configuration diagram illustrating a second exemplary embodiment of the present invention. The second exemplary embodiment is different from the first exemplary embodiment in that the image enhancement unit 14 performs an image enhancement process using frequency component images.

The image enhancement unit 14 performs enhancement processes for individual frequency bands in an original image in accordance with weighted values in band-weighted images corresponding to the respective frequency bands, which are generated by the band-weighted image generation unit 13, and in accordance with frequency component images of the respective frequency bands obtained by the band decomposition unit 11 as a result of decomposition.

In an enhancement process using a frequency component image, for example, a pixel value Pᵢⱼ of an enhanced image may be calculated by multiplying a pixel value sᵢⱼ of a frequency component image by a coefficient k and performing a calculation on a pixel value pᵢⱼ of an original image using:

Pᵢⱼ=pᵢⱼ+ksᵢⱼ (5)

Adding the value ksᵢⱼ in Equation (5) to Equation (2) above provides an enhanced feature (frequency characteristic) in the corresponding frequency band.

In Equation (5), the value of the coefficient k may be changed from frequency component image to frequency component image. For example, in an image including a larger number of frequency components of a certain frequency band than the frequency components of the other frequency bands, the value k may be set larger for the frequency component image of the frequency band. Conversely, if the frequency components of a certain frequency band are more pronounced than the frequency components of the other frequency bands, the value k may be set smaller.

Further, the frequency component images of the respective directions illustrated in FIG. 12, which are obtained using Equation (4), may be used as frequency component images to be used. In this case, noise such as points having no directivity is not enhanced.

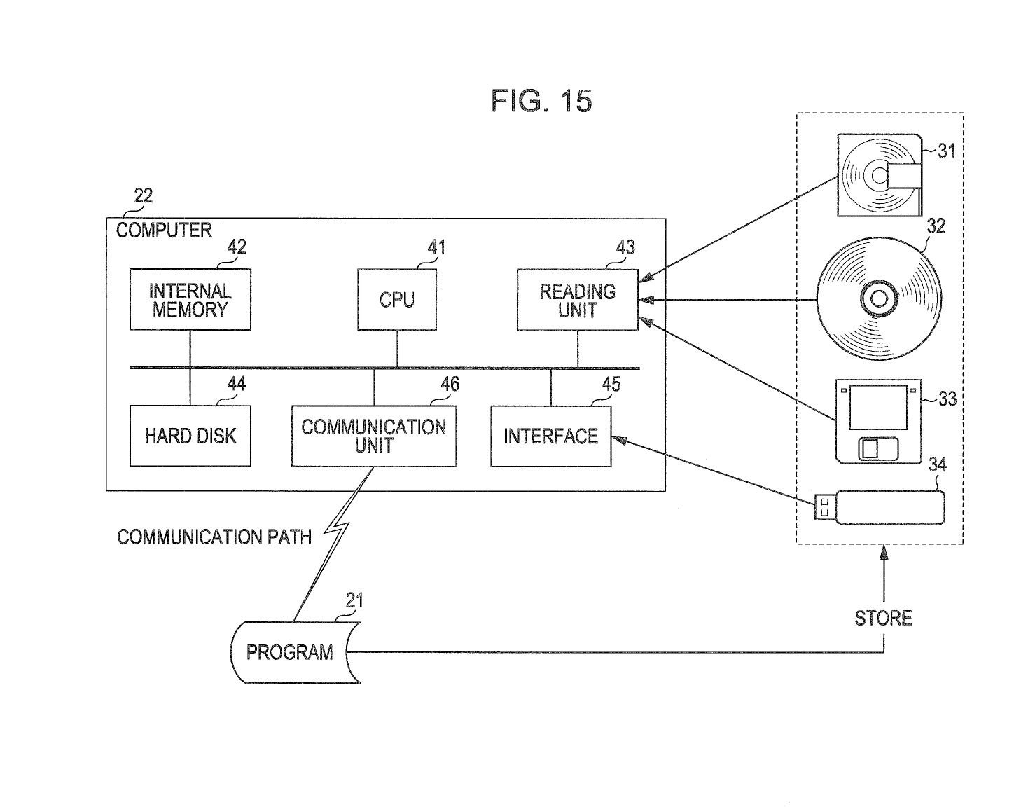

FIG. 15 is a diagram depicting an example of a computer program, a storage medium storing the computer program, and a computer when the functions described in the respective exemplary embodiments of the present invention are implemented by a computer program.

All or some of the functions of the units described in the foregoing exemplary embodiments of the present invention may be implemented by a computer-executable program 21. In this case, the program 21 and data used in the program 21 may be stored in a computer-readable storage medium. The term “storage medium” means a medium through which content written in a program is transmitted to a reading unit 43 provided in a hardware resource of a computer 22 in the form of a signal corresponding to a change in the state of magnetic, optical, electric, or any other suitable energy caused by the content written in the program. Examples of the storage medium include a magneto-optical disk 31, an optical disk 32 (including a compact disk (CD) and a digital versatile disk (DVD)), a magnetic disk 33, and a memory 34 (including an IC card and a memory card). It is to be understood that the storage medium may or may not be a portable storage medium.

All or some of the functions described in the foregoing exemplary embodiments of the present invention are implemented by storing the program 21 in a storage medium such as that described above, placing the storage medium in, for example, the reading unit 43 or an interface 45 of the computer 22, reading the program 21 using the computer 22, storing the program 21 in an internal memory 42 or a hard disk 44, and executing the program 21 by using a central processing unit (CPU) 41. Alternatively, all or some of the functions described in the foregoing exemplary embodiments of the present invention may be implemented by transferring the program 21 to the computer 22 via a communication path, receiving the program 21 using a communication unit 46 in the computer 22, storing the program 21 in the internal memory 42 or the hard disk 44, and executing the program 21 by using the CPU 41.

The computer 22 may be connected to other various devices via the interface 45. The computer 22 may also be connected to, for example, a display that displays information, a receiver that receives information from a user, and any other suitable device. Furthermore, for example, an image forming device serving as an output device may be connected to the computer 22 via the interface 45, and an image subjected to an enhancement process may be formed using the image forming device. Each configuration may not necessarily be supported by a single computer, and processes may be executed by different computers depending on the processes.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a band decomposition unit that decomposes a given original image into frequency component images each corresponding to an individual frequency band;
an intensity calculation unit that sets each pixel as a target pixel for processing and that calculates an intensity of a frequency component in each frequency band for a local area having a predetermined size including the target pixel for processing; and
a band-weighted image generation unit that generates a band-weighted image by determining a frequency band to which the target pixel for processing belongs in accordance with intensities of frequency components in the local area and by assigning a weighted value for the frequency band to each pixel in the local area.

2. The image processing apparatus according to claim 1, further comprising an enhancement unit that performs an enhancement process for each frequency band in the original image in accordance with a weighted value in a band-weighted image corresponding to the frequency band, the band-weighted image being generated by the band-weighted image generation unit.

3. The image processing apparatus according to claim 1, wherein the band decomposition unit decomposes the original image in accordance with frequency bands and orientations.

4. The image processing apparatus according to claim 1, wherein the band-weighted image generation unit assigns a weighted value corresponding to a distance from the target pixel for processing to each pixel in the local area.

5. The image processing apparatus according to claim 1, wherein the band-weighted image generation unit generates the band-weighted image by adding the weighted value for the frequency band assigned to each pixel in the local area to a previous weighted value assigned to the pixel.

6. An image processing method comprising:
decomposing a given original image into frequency component images each corresponding to an individual frequency band;
setting each pixel as a target pixel for processing and calculating an intensity of a frequency component in each frequency band for a local area having a predetermined size including the target pixel for processing; and
generating a band-weighted image by determining a frequency band to which the target pixel for processing belongs in accordance with intensities of frequency components in the local area and by assigning a weighted value for the frequency band to each pixel in the local area.

7. A computer readable medium storing a program causing a computer to execute a process, the process comprising:
decomposing a given original image into frequency component images each corresponding to an individual frequency band;
setting each pixel as a target pixel for processing and calculating an intensity of a frequency component in each frequency band for a local area having a predetermined size including the target pixel for processing; and
generating a band-weighted image by determining a frequency band to which the target pixel for processing belongs in accordance with intensities of frequency components in the local area and by assigning a weighted value for the frequency band to each pixel in the local area.
